(19) United States
(12) Patent Application Publication
(10) Pub. No.: US 2023/0182208 A1
(43) Pub. Date: Jun. 15, 2023

(54) METHOD FOR THE ADDITIVE MANUFACTURE OF AN OBJECT FROM A POWDER LAYER

(71) Applicant: AddUp, Cebazat (FR)

(72) Inventors: FRANCK DENAVIT, CEBAZAT (FR); ETIENNE BLANCHET, Cebazat (FR); CAMILLE DELORME, Cebazat (FR)

(21) Appl. No.: 17/924,594

(22) PCT Filed: May 11, 2021
(86) PCT No.: PCT/FR2021/050806

§ 371 Date: Nov. 10, 2022

(30) Foreign Application Priority Data
May 12, 2020 (FR) FR2004676

(51) Int. Cl. B22F 10/366; B22F 10/28; B22F 12/49; B33Y 50/02; B33Y 10/00; B33Y 30/00; B29C 64/153; B29C 64/393; B29C 64/268

(52) U.S. Cl. CPC B22F 10/366; B22F 10/28; B22F 12/49; B33Y 50/02; B33Y 10/00; B33Y 30/00; B29C 64/153; B29C 64/393; B29C 64/268; B22F 2998/10; B22F 2304/10

(57) ABSTRACT

A method for the additive manufacture of an object from a powder layer comprises the steps of: projection (200) of an energy beam onto a surface of the layer to form a spot; outward scanning (202) by the beam of a first zone of the surface in a longitudinal direction and orientation of the beam so that the spot travels the first zone in a trajectory comprising first loops offset in the longitudinal direction, the spot travelling each first loop in a first rotation sense; and return scanning (204) by the beam of a second zone of the surface in the longitudinal direction and orientation of the beam so that the spot travels the second zone in a trajectory comprising second loops offset in the longitudinal direction, the spot travelling each second loop in a second rotation sense opposite to the first rotation sense.

### FIELD OF THE INVENTION

The present invention concerns a method for the additive manufacture of an object from a powder layer and a device adapted to execute a method of that kind.

### PRIOR ART

Additive manufacture consists in producing an object by melting layers of powder superposed on one another. Those layers correspond to different sections of the object to be manufactured.

To melt a powder layer a source projects an energy beam onto the surface of that powder layer to form a spot in which such melting occurs. The energy beam is then controlled so as to scan the surface in order to propagate that melting over all the surface of the layer.

The energy beam conventionally scans different zones of the surface in a longitudinal direction and alternately in an outward sense and in a return sense.

It has in particular been proposed to control the energy source so that the spot does not travel each zone in a perfectly rectilinear movement in translation in the longitudinal direction, but in a movement composed of a movement in translation in the longitudinal direction and an oscillatory movement (known as “wobbling”). The oscillatory movement oscillates in particular in a transverse direction in such a manner as to widen the melt pool.

Various oscillatory movements have been proposed.

One of them, generally referred to as “circular mode”, is such that the spot follows a trajectory comprising loops offset relative to one another in the longitudinal direction.

FIG. 1 shows a trajectory followed by the spot during the execution of a method using a circular mode of this kind. In FIG. 1 the longitudinal direction is horizontal and the transverse direction is vertical. The outward sense goes from left to right and the return sense goes from right to left. Four successions of loops, located in four distinct zones, are represented in FIG. 1. Two of the four zones have been travelled in the outward sense and the other two in the return sense, as the four dashed line arrows show. The spot travels each loop in a constant rotation sense. The rotation sense is the same for each of the four zones and in particular for each loop. Consequently, two adjacent successions of loops are head-to-tail.

### SUMMARY OF THE INVENTION

An object of the invention is more homogenous distribution of the energy furnished by an energy beam to a powder layer during additive manufacture without this reducing the manufacturing time. To this end there is proposed, in a first aspect, a method for the additive manufacture of an object from a powder layer, comprising steps of:

projection of an energy beam onto a surface of the powder layer to form a spot so as to melt the powder,

the energy beam scanning a first zone of the surface in a longitudinal scanning direction and in an outward sense and, during the scanning of the first zone, orientation of the energy beam so that the spot travels the first zone in a trajectory comprising first loops offset relative to one another in the longitudinal scanning direction, the spot travelling each first loop in a first rotation sense,

the energy beam scanning a second zone of the surface in the longitudinal scanning direction and in a return sense opposite to the outward sense, the second zone being adjacent to the first zone in a transverse scanning direction perpendicular to the longitudinal scanning direction, and during the scanning of the second zone orientation of the energy beam so that the spot travels the second zone in a trajectory comprising second loops offset from one another in the longitudinal scanning direction, the spot travelling each second loop in a second rotation sense opposite to the first rotation sense. The inventors had noted that, because of the asymmetric shape of the loops travelled by the spot, more energy was deposited at the base of the loops than at their summit. Consequently, when two adjacent successions of loops are head-to-tail as represented in FIG. 1 the energy deposited on the layer varies greatly in the transverse direction: this energy is high close to the bases of the facing loops and lower close to the summits of the facing loops.

Changing the sense travelled by the loops between the first zone and the second zone makes it possible for the succession of first loops and the succession of second loops no longer to be head-to-tail, as in FIG. 1, but oriented in the same sense in the transverse direction. Thus the bases of first loops are close to the summits of the second loops or the summits of the first loops are close to the bases of the second loops, which in both cases makes it possible to reduce the variations of energy in the transverse direction. This is why the deposition of energy is more homogeneous.

Moreover, scanning the first zone in an outward sense and the second zone in a return sense makes it possible to scan all of these two zones rapidly. This is why the improved homogeneity offered by the method in the first aspect does not compromise its speed of execution.

The method according to the first aspect may have the following optional features, separately or in combination where that is technically possible.

At least two of the first loops and/or at least two of the second loops preferably cross over.

At least two of the first loops and/or at least two of the second loops preferably have the same dimensions.

The succession of second loops is preferably at a distance from the succession of first loops in the transverse scanning direction.

At least one of the loops preferably extends over an amplitude measured in the transverse scanning direction between 100 micrometres and 2 millimetres inclusive.

The energy beam preferably oscillates in the transverse scanning direction at a frequency of at least 1 kHz.

The energy beam is preferably a laser beam or an electron beam.

There is also proposed, in a second aspect, a device for the additive manufacture of an object from a powder layer, the device comprising an energy source configured:

to project an energy beam onto a surface of the powder layer to form a spot so as to melt the powder,

to command scanning by the energy beam of a first zone of the surface in a longitudinal scanning direction and in an outward sense and, during the scanning of the first zone, orientation of the energy beam so that the spot travels the first zone in a trajectory comprising first loops offset relative to one another in the longitudinal scanning direction, the spot travelling each first loop in a first rotation sense,

to command scanning by the energy beam of a second zone of the surface in the longitudinal scanning direction and in a return sense opposite to the outward sense, the second zone being adjacent to the first zone in a transverse scanning direction perpendicular to the longitudinal scanning direction, and during the scanning of the second zone, orientation of the energy beam so that the spot travels the second zone in a trajectory comprising second loops offset from one another in the longitudinal scanning direction, the energy beam travelling each second loop in a second rotation sense opposite to the first rotation sense.

### DESCRIPTION OF THE FIGURES

Other features, objects and advantages of the invention will emerge from the following purely illustrative and non-limiting description that must be read with reference to the appended drawings in which:

FIG. 1, already discussed, represents a trajectory followed by a spot resulting from the projection of an energy beam onto a surface using a prior art method.

FIG. 2 is a diagrammatic view of an additive manufacturing device in a first embodiment.

FIG. 3 is a perspective view of the additive manufacturing device already represented in FIG. 2.

FIG. 4 is a perspective view of an additive manufacturing device in a second embodiment.

FIG. 5 is a flowchart of steps of a method of additive manufacture in a first embodiment.

FIG. 6 represents a trajectory followed by a spot resulting from the projection of an energy beam onto a surface during the execution of the method to which FIG. 4 relates.

In all the figures similar elements bear identical references.

### DETAILED DESCRIPTION OF THE INVENTION

Additive Manufacturing Device

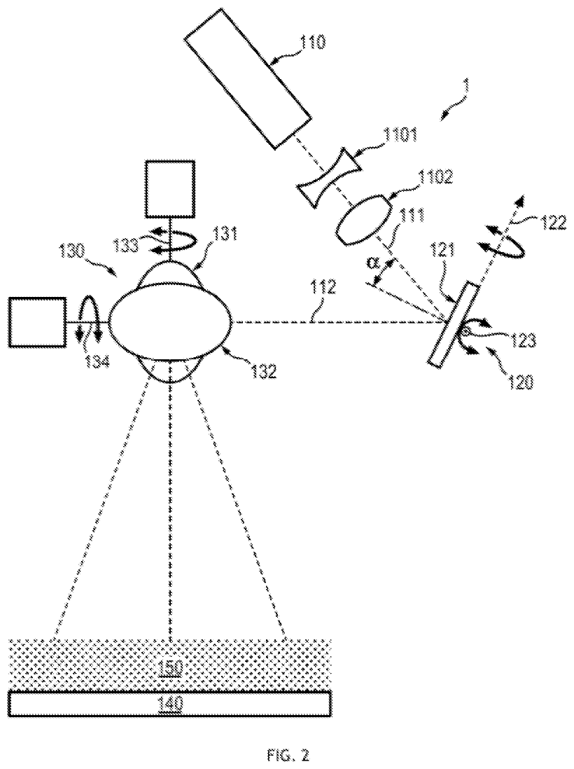

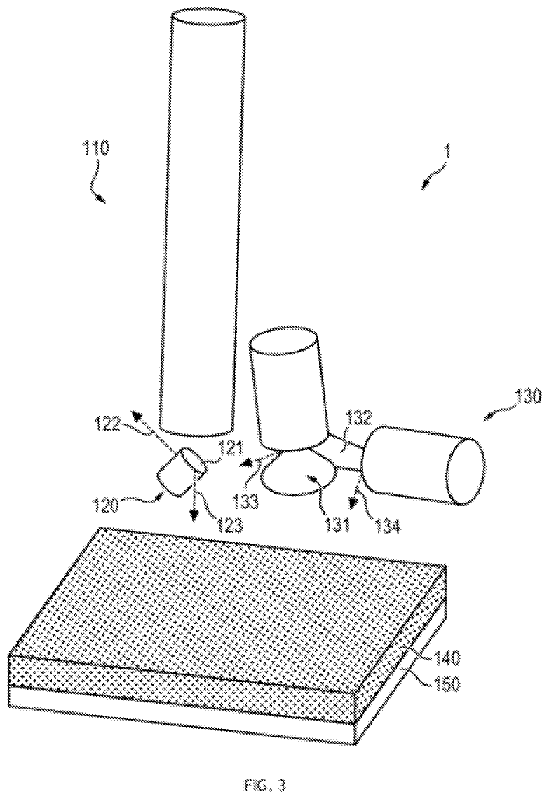

Referring to FIGS. 2 and 3, an additive manufacturing device comprises an energy source 1 in a first embodiment and a support 140.

The support 140 has a free, typically plane, surface extending in two directions: a longitudinal direction and a transverse direction perpendicular to the longitudinal direction. Hereinafter and by convention X denotes the longitudinal direction and Y the transverse direction.

The function of the free surface of the support 140 is to serve as a supporting surface 140 for a powder layer 150 or a plurality of layers 150 stacked on one another.

As a general rule, the energy source 1 is adapted to project an energy beam toward the support 140. When a powder layer 150 is deposited on the support 140 this energy beam is projected onto an upper surface of that layer 150 to form a spot.

The energy source 1 comprises in particular a generator 110 configured to generate the energy beam. The generator 110 is for example a laser source; the beam generated is then a laser beam comprising photons, in other words a light beam. Alternatively, the generator 110 is of EBM (Electron Beam Melting) type, that is to say a type adapted to generate a beam of electrons. Hereinafter the non-limiting situation is that of a laser beam.

The energy source 1 further comprises a focusing device adapted to adjust the focusing of the light beam. This focusing device therefore makes it possible to vary the size of the spot in the form of which the beam is projected onto the upper surface of a powder layer 150 deposited on the support 140. The focusing device comprises for example a focusing element 1102 and a focusing lens 1101 mobile in translation relative to the focusing element parallel to an optical axis of the lens. The focusing lens 1101 is arranged downstream of the beam generator 110. Hereinafter the terms “upstream” and “downstream” implicitly refer to a direction of propagation of the energy beam on an optical path from the generator 110 to the support 140.

The focusing device comprises an actuator for moving the focusing lens 1101 relative to the focusing element 1102.

The energy source 1 further comprises a scanning device 130 adapted to orient the energy beam so that the spot where that beam is projected is mobile relative to the support 140, over the surface of the layer 150, in the longitudinal direction and in the transverse direction.

The scanning device 130 is arranged downstream of the focusing device.

The scanning device 130 comprises for example a first scanning mirror 131 mobile in rotation relative to the support 140 about a first rotation axis 133 and a second scanning mirror 132 mobile in rotation relative to the support 140 about a second rotation axis 134 different from the first rotation axis. For example, the first rotation axis 133 is in the longitudinal direction and the second rotation axis 134 is in the transverse direction. One of the two scanning mirrors 131, 132 is arranged downstream of the other scanning mirror so that an energy beam from the generator 110 is reflected sequentially at the two scanning mirrors before being redirected toward the support 140.

Alternatively, the scanning device 130 comprises a single scanning mirror mobile in rotation relative to the support 140 about the first rotation axis 133 and about the second rotation axis 134. In this case this single scanning mirror is arranged so that an energy beam from the generator 110 is reflected at this scanning mirror before being redirected toward the support 140.

The scanning device 130 moreover comprises at least one actuator (one for each scanning mirror used). The function of each actuator is to move a scanning mirror in rotation over a range of scanning angles. The ranges of scanning angles are for example adapted to enable the spot to cover all the surface of the layer 150, or at least most of the latter.

For a given configuration of the scanning device the central axis of a beam emanating from the generator 110 intersects the surface of the support 140 at a specific point. There therefore exists a mathematical relation between the coordinates (x, y) of that point and the angular position of the scanning mirrors 131, 132.

The scanning device 130 is in particular configured to induce movement in translation of the spot projected onto the surface of the powder layer 150 in a longitudinal scanning direction, in an outward sense and in a return sense opposite to the outward sense, and to do this alternately, the longitudinal scanning direction being chosen independently of the longitudinal and transverse directions of the support 140.

In the first embodiment the energy source 1 further comprises an oscillation device 120 adapted to cause oscillation of an energy beam emanating from the generator 110 and consequently also to cause oscillation of the spot where the energy beam is projected in at least one oscillation direction over the surface of a powder layer 150 deposited on the support 140.

The oscillation device 120 comprises for example an oscillation mirror mobile in rotation relative to the support 140 about two different oscillation axes 122, 123.

The oscillation device 120 further comprises an actuator adapted to cause oscillation of the oscillation mirror at a given fixed or variable frequency.

The actuator of the oscillation device 120 is configured to cause the oscillation mirror to oscillate about oscillation axes 122, 123 over two ranges of oscillation angle smaller than the ranges of scanning angle over which each scanning mirror 131, 132 is mobile in rotation about axes 133, 134. The ranges of oscillation angle used by the oscillation device 120 are adapted to enable the projected spot to oscillate over an amplitude between 100 micrometres and 2 millimetres inclusive.

The scanning device 130 and the oscillation device 120 are configured to cooperate so that the spot is able to move over the surface of the powder layer 150 deposited on the support 140 in a movement composed of a movement in translation induced by the scanning device 130 and an oscillatory movement induced by the oscillation device 120. In other words, the oscillatory movement modulates the movement in translation induced by the scanning device 130.

The oscillation device 120 is arranged upstream of the scanning device 130. In other words, an energy beam from the generator 110 is reflected at the oscillation mirror before reaching the scanning device 130.

The oscillation device 120 is for example arranged downstream of the focusing device.

The laser source 110, the modulation device 120 and the scanning device 130 are for example arranged so as to enable a surface melting rate, that is to say the surface area of the powder layer 150 covered by the laser spot per unit time, greater than 1000 cm²/min, for example greater than 2000 cm²/min, for example greater than 4000 cm²/min, for example less than 15000 cm²/min, for example less than 10000 cm²/min, for example of the order of 6000 cm²/min.

The modulation device 120 and the scanning device 130 are for example configured to enable a speed of movement of the spot between 0.5 and 10 m/s inclusive, for example between 1 and 5 m/s inclusive, for example equal to 1 or 2 m/s.

The energy source 1 further comprises a control unit (not shown) configured to control the focusing device, the scanning device 130 and the oscillation device 120. This control unit is in particular configured to control the respective actuators of these various devices.

The control unit may comprise or be coupled to a memory storing a table of values of focusing parameters precalculated for different pairs of coordinates (x, y) in the plane of the free surface of the support 140. Thus the control unit is configured, when the spot is centred at a point with coordinates (x, y) on the surface of the support, to control the focusing device using the focusing parameter value associated with that pair in the table of precalculated values.

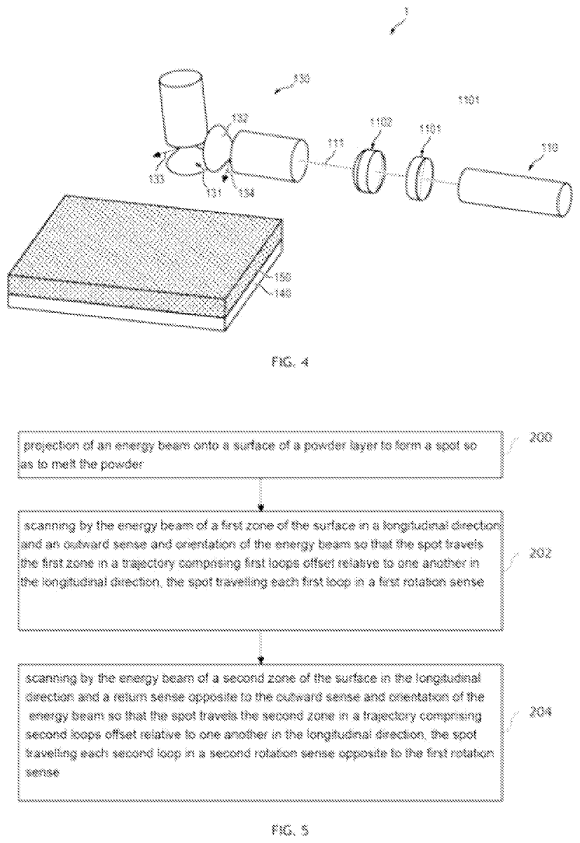

There is represented in FIG. 4 a second embodiment of the energy source 1. This second embodiment differs from the first embodiment in that it comprises no oscillation device 120. On the other hand, in the second embodiment the device 130 is configured, on its own, so that the spot is able to move over the surface of the powder layer 150 deposited on the support 140 in a movement composed of a movement in translation induced by the scanning device 130 and an oscillatory movement that would be induced by the oscillation device 120 if it were present in this second embodiment. This is made possible by causing the scanning mirror or mirrors to oscillate.

Additive Manufacturing Method

Referring to FIG. 4, an additive manufacturing method using the device described above comprises the following steps.

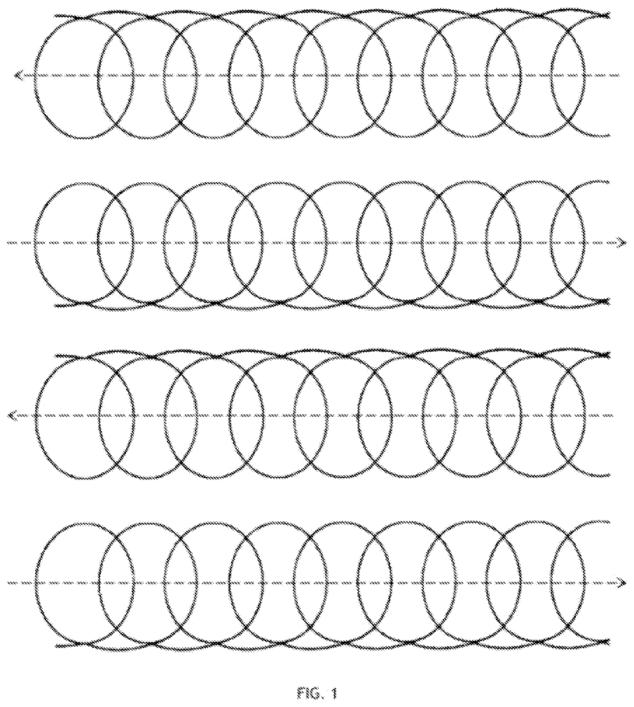

At least one powder layer 150 is deposited on the support 140 as represented in FIG. 1. The powder layer 150 has a free surface extending in longitudinal and transverse directions of the support 140. The grains of powder have for example a particle size between 10 and 100 μm inclusive, for example between 20 and 60 μm, for example equal to 40 μm.

The material of each powder layer 150 has for example a fluence between 0.5 and 10 J/mm² inclusive, for example between 1 and 5 J/mm² inclusive, for example equal to 2 J/mm².

The material of the or each powder layer 150 may comprise titanium and/or aluminium and/or Inconel and/or stainless steel and/or maraging steel. The material of the or each powder layer 150 may be constituted of titanium and/or aluminium and/or Inconel and/or stainless steel and/or maraging steel. The generator 110 is activated so as to emit an energy beam. That energy beam passes through the focusing device, the oscillation device 120 (if present in the energy source 1) and the scanning device 130 before it is projected onto the free surface of the powder layer 150 in the form of a spot (step 200). The powder layer 150 is therefore heated at the level of this spot, to the point of causing its grains to melt.

The focusing device moreover adjusts the focusing of the beam so as to reduce the size of this spot and therefore to concentrate more the energy conveyed by the energy beam.

The scanning device 130 orients the beam so that the spot is moved in translation in a longitudinal scanning direction, in an outward sense, over a first zone of the surface. This movement in translation is represented in FIG. 6 by dashed line arrows (step 202).

During step 202 the scanning device 130 or the oscillation device 120 causes the beam to oscillate so that this movement in translation is modulated by an oscillatory movement. This oscillatory movement comprises a transverse oscillation component in a transverse scanning director perpendicular to the longitudinal scanning direction and a longitudinal oscillation component in the longitudinal scanning direction. In other words, this oscillatory movement generates an oscillation of this spot over the surface of the powder layer 150 not only in the transverse scanning direction but also in the longitudinal scanning direction.

When the source 1 conforms to the first embodiment the oscillatory movement is induced by the oscillation device 120. When the source 1 conforms to the second embodiment the oscillatory movement is induced by the scanning device 130.

The two oscillation components preferably oscillate at the same frequency. The oscillatory movement can then be ellipsoidal if the two components are of sinusoidal form.

Because of the composition of this oscillatory movement and of the movement in translation in the outward sense, in the first zone the spot follows a trajectory comprising a succession of first loops offset from one another in the longitudinal scanning direction.

Each loop has a node, which is a point through which the spot passes twice. Each loop moreover comprises an upstream portion, a hairpin-shape intermediate portion and a downstream portion. The spot travels the various portions of a loop in this order: the upstream portion, the node, the hairpin-shape intermediate portion, the node again, and finally the downstream portion. This downstream part is connected to the upstream part of the next loop. In travelling a loop the spot turns about a central point of the loop always in the same rotation sense, termed the first rotation sense.

Each loop comprises a base formed by its upstream portion, its downstream portion and the node. Each loop comprises a summit formed by its intermediate portion. Because of its asymmetrical shape the quantity of energy deposited by the beam at the base of a loop (in particular close to the node) is greater than the quantity of energy deposited at the summit of that loop.

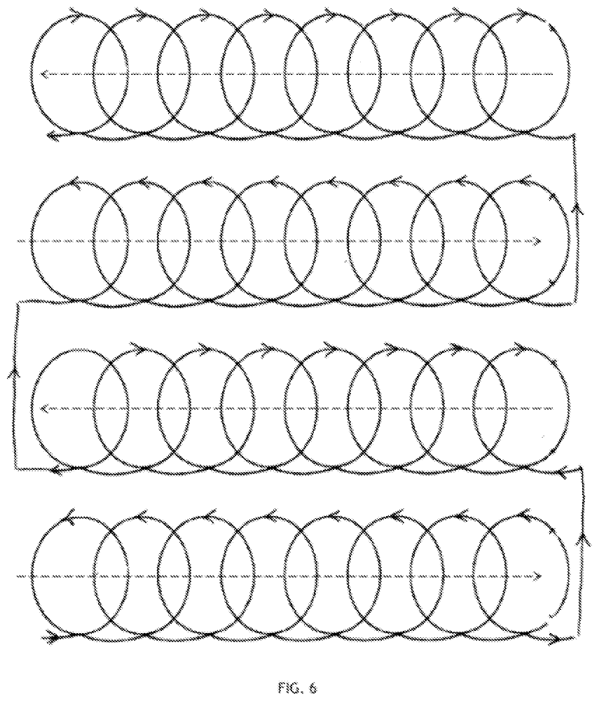

In FIG. 5 the longitudinal scanning direction is horizontal and the outward sense goes from left to right and the first rotation sense is an anticlockwise rotation sense. It follows that the respective bases of the first loops are below the summits of those first loops.

If the two components of the oscillatory movement have the same amplitude the oscillatory movement becomes circular. Consequently, each first loop has a form that tends more toward a circle.

At least one first loop preferably extends over a height measured in the transverse scanning direction between 100 micrometres and 2 millimetres inclusive. This height corresponds to the amplitude of the transverse component of the oscillatory movement.

Moreover, it is preferable for the scanning device 130 (in the second embodiment of the energy source 1) or the oscillation device 120 (in the first embodiment of the energy source 1) to cause the spot to oscillate in the transverse direction at a frequency of at least 1 kHz. This frequency is typically between 1 kHz and 10 kHz inclusive when the energy beam is a laser beam or between 1 kHz and 100 kHz inclusive when the energy beam is an electron beam.

All the first loops are travelled by the spot in the first rotation sense.

All the first loops preferably have the same dimensions (the same height between their base and their summit, measured in the transverse direction, and/or the same width, measured in the longitudinal direction).

At least two of the first loops cross over, that is to say a current first loop crosses a preceding loop at two intersection points at least. All the first loops preferably cross over two by two.

The succession of first loops extends over a certain length in the longitudinal scanning direction and over a certain width in the transverse scanning direction.

The scanning device 130 then orients the energy beam so as to move the spot in the transverse scanning direction, for example in translation, so that the spot reaches a second zone that is adjacent to the first zone (for example above the first zone in the situation illustrated in FIG. 5).

The scanning device 130 then orients the beam so that the spot is moved over the second zone in translation in the longitudinal scanning direction, but this time in a return sense opposite to the outward sense (step 204).

During the step 204 the scanning device 130 or the oscillation device 120 causes the beam to oscillate so that this movement in translation is modulated by an oscillatory movement so that in the second zone the spot follows a trajectory comprising a succession of second loops offset from one another in the longitudinal scanning direction. This time all the first loops are travelled by the spot in a second rotation sense.

As for the step 202, the oscillatory movement is induced by the oscillation device 120 when the source 1 conforms to the first embodiment or by the scanning device 130 when the source 1 conforms to the second embodiment. The second rotation sense is opposite to the first rotation sense. This change of the sense in which the loop is travelled is typically obtained by acting on the oscillation parameters used to cause the beam to oscillate.

In FIG. 5 the return sense goes from right to left and the second rotation sense of the spot over the second loops is a clockwise rotation sense. It follows from this that the respective bases of the second loops are below the summits of the same second loops, as is already the case for the first loops discussed above. Consequently the energy transported by the energy beam onto the powder layer 150 is distributed in a more homogeneous manner over the combination of the first zone and the second zone.

At least one second loop preferably extends over a height, measured in the transverse scanning direction, between 100 micrometres and 2 millimetres inclusive. This height corresponds to the amplitude of the transverse component of the oscillatory movement.

Moreover, it is preferable for the source 1 to cause the spot to oscillate in the transverse scanning direction in the second zone at a frequency of at least 1 kHz. This frequency is typically between 1 kHz and 10 kHz inclusive when the energy beam is a laser beam or between 1 kHz and 100 kHz when the energy beam is an electron beam.

All the second loops preferably have the same dimensions (the same height between their base and their summit, measured in the transverse scanning direction, and/or the same width, measured in the longitudinal scanning direction).

At least two of the second loops cross over. All the second loops preferably cross over two by two. The succession of second loops is at a distance from the succession of first loops (as represented in FIG. 5). Alternatively, at least one second loop crosses over a first loop.

The foregoing steps, in particular steps 202 and 204, are repeated alternately. In such a manner as to cover a greater number of zones adjacent to one another in the transverse scanning direction (four zones are represented in FIG. 5).

1-8. (canceled)

9. A method of additive manufacturing of an object from a powder layer, the method comprising:
projecting an energy beam onto a surface of the powder layer to form a spot so as to melt the powder;
scanning a first zone of the surface with the energy beam in a forward longitudinal scanning direction, and, during the scanning of the first zone, directing the energy beam so that the spot travels the first zone in a trajectory comprising first loops offset relative to one another in the forward longitudinal scanning direction, wherein the spot travels each of the first loops by rotating in a first rotation direction; and
scanning a second zone of the surface with the energy beam in a backward longitudinal scanning direction opposite to the forward longitudinal scanning direction, the second zone being adjacent to the first zone in a transverse scanning direction perpendicular to the forward longitudinal scanning direction, and during the scanning of the second zone, directing the energy beam so that the spot travels the second zone in a trajectory comprising second loops offset from one another in the backward longitudinal scanning direction, wherein the spot travels each second loop by rotating in a second rotation direction opposite to the first rotation direction.

10. The method according to claim 9, wherein at least two of the first loops cross over or at least two of the second loops cross over.

11. The method according to claim 9, wherein at least two of the first loops have the same dimensions or at least two of the second loops have the same dimensions.

12. The method according to claim 9, wherein the second loops are away from the first loops in the transverse scanning direction.

13. The method according to claim 9, wherein at least one of the first loops has an amplitude measured in the transverse scanning direction which is between 100 micrometers and 2 millimeters inclusive.

14. The method according to claim 9, wherein the energy beam oscillates in the transverse scanning direction at a frequency greater than or equal to 1 kHz.

15. The method according to claim 9, wherein the energy beam is a laser beam or an electron beam.

16. A device for additive manufacturing of an object from a powder layer, the device comprising an energy source configured to project an energy beam onto a surface of the powder layer in the form of a spot so as to melt the powder, the energy source comprising a control unit configured to:
cause the energy beam to scan a first zone of the surface in a forward longitudinal scanning direction and, during the scanning of the first zone, direct the energy beam so that the spot travels the first zone in a trajectory comprising first loops offset relative to one another in the forward longitudinal scanning direction, wherein the spot travels each of the first loops in a first rotation direction; and
cause the energy beam to scan a second zone of the surface in a backward longitudinal scanning direction opposite to the forward longitudinal scanning direction, the second zone being adjacent to the first zone in a transverse scanning direction perpendicular to the forward longitudinal scanning direction, and during the scanning of the second zone, direct the energy beam so that the spot travels the second zone in a trajectory comprising second loops offset from one another in the longitudinal scanning direction, wherein the spot travels each of the second loops in a second rotation direction opposite to the first rotation direction.
